(19) United States
(12) Patent Application Publication
(10) Pub. No.: US 2011/0277582 A1
(43) Pub. Date: Nov. 17, 2011

(54) Control panel

(75) Inventors: Dieter Hilzinger, Gernsbach (DE); Luis Gonzalez, Hollywood, FL (US)

(73) Assignee: Becker Flugfunkwerk GmbH, Rheinmuenster (DE)

(21) Appl. No.: 13/066,879

(22) Filed: Apr. 27, 2011

(30) Foreign Application Priority Data
May 11, 2010 (DE) 20 2010 006 707.3

(51) Int. Cl. G05G 1/02; G05G 1/08; G05G 1/00

(52) U.S. Cl. 74/503; 74/469

(57) ABSTRACT

A control panel for a communications system of an aircraft has at least one transmitter and at least one receiver, with multiple transmission and reception channels, and multiple operating elements that have an on/off function, in each instance. Each operating element is assigned to one of the transmission and reception channels. Reception on the transmission and reception channel, in each instance, can be released by the on/off function. A selection switch has a selection position for each transmission and reception channel, in which it releases the related transmission and reception channel for the transmission and blocks the other transmission and reception channels for transmission. The selection switch has a further selection position, in which it releases the transmission and reception channels that are released for reception by the operating elements, for transmission, and blocks the other transmission and reception channels for transmission.

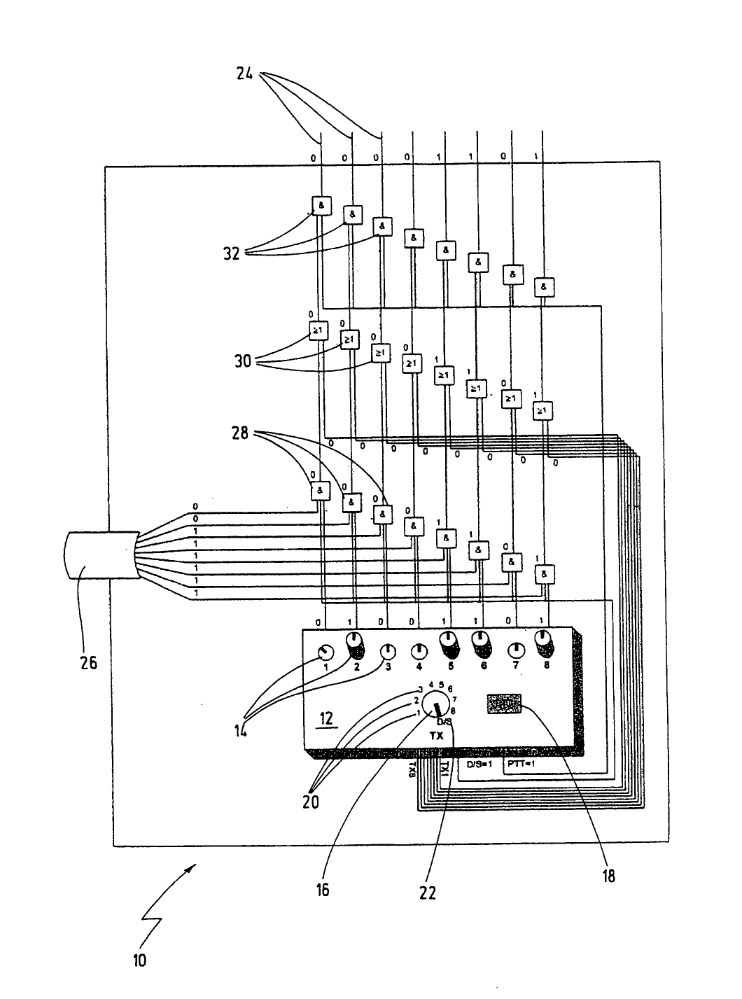

### CROSS REFERENCE TO RELATED APPLICATIONS

Applicants claim priority under 35 U.S.C. §119 of German Application No. 20 2010 006 707.3 filed May 11, 2010, the disclosure of which is incorporated herein by reference.

### BACKGROUND OF THE INVENTION

1. Field of the Invention

The present invention relates to a control panel for a communications system of an aircraft.

2. Description of the Related Art

Such control panels, which are called audio control panels in the technical idiom, are in widespread use in aircraft such as airplanes or helicopters. Every work station of a crew member who must communicate with other crew members or radio stations outside the aircraft or both is equipped with such a control panel. The connection between the operator and the transmission and reception system of the aircraft is produced by way of the control panel. The control panel allows the crew member, in each instance, to receive and transmit audio data via multiple channels. Rotary/push buttons on the control panel determine the channels by way of which the crew member can receive audio data. Pressing such a button releases the channel connected with this button for reception. The volume of reception is adjusted by rotating the button. Known control panels of the type indicated initially furthermore have a selection switch with which the channel is selected, by way of which the operator can transmit audio data. Always only one channel at a time, by way of which the operator can transmit audio data, however, can be selected using the selection switch.

### SUMMARY OF THE INVENTION

It is therefore an object of the present invention to further develop a control panel of the type stated initially, in such a manner that improved communication is made possible.

These and other objects are achieved by a control panel for a communication system of an aircraft according to the invention. The control panel has at least one transmitter and at least one receiver, with multiple transmission and reception channels, and multiple operating elements that have an on/off function, in each instance. Each operating element is assigned to one of the transmission and reception channels, and reception on the transmission and reception channel, in each instance, can be released by means of the on/off function. A selection switch has a selection position for each transmission and reception channel, in which it releases the related transmission and reception channel for transmission and blocks the other transmission and reception channels for transmission. The selection switch also has a further selection position, in which it releases the transmission and reception channels that are released for reception by means of the operating elements, for transmission, and blocks the other transmission and reception channels for transmission. Advantageous further developments of the invention are discussed below.

The invention is based on the idea of providing the selection switch with an additional function, which makes it possible for an operator to simultaneously transmit audio data on all channels on which he/she can simultaneously receive audio data. Then, complicated switching back and forth between the channels is no longer necessary. Audio data may be transmitted by way of different channels in one step without having to be individually repeated for every channel.

It is practical if the operating elements have a volume control, in each instance. Advantageously, the operating elements are rotary/push buttons where the volume control is operated by rotation and the on/off function is operated by pressing the button, in each instance.

According to an advantageous further development of the invention, an on/off switch is provided, which is connected with the selection switch by means of a logical AND, and releases or blocks the transmission and reception channels released by the selection switch for transmission. Such switches are usually referred to as PTT (push-to-talk) switches. In order to be able to transmit, the operator must press the PTT switch disposed on his/her control panel.

It is practical if a blocking device is provided, by means of which the pre-selected transmission and reception channels can be blocked for transmission. Then, it is not possible to transmit on these channels, right from the start, but only to receive. This arrangement is particularly advantageous if certain channels are intended only for reception. By means of blocking using the blocking device, it can be precluded that an operator accidentally transmits on one of these channels.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings:

The sole FIGURE is a schematic representation as a block diagram of a control panel for a communications system of an aircraft in accordance with an embodiment of the invention.

### DETAILED DESCRIPTION OF PREFERRED EMBODIMENTS

The control panel 10 shown in the sole FIGURE has a front plate 12 that faces an operator. Eight rotary/push buttons 14 are disposed in the front plate 12, as operating elements. Furthermore, a selection switch 16 configured as a rotary switch and an on/off switch 18 configured as a push button are disposed in front plate 12. Selection switch 16 has eight selection positions 20 indicated with the numbers 1 to 8, which are assigned to one of the rotary/push buttons 14, in each instance. Furthermore, selection switch 16 has another selection position 22, indicated with D/S. Eight transmission and reception channels of a communications system of an airplane are connected with control panel 10, whereby one of the rotary/push buttons 14 is assigned to each transmission and reception channel 24.

The operator can select the channels 24 by way of which he/she can receive audio data, using the rotary/push buttons 14. For reception of audio data by way of one of the channels 24, the corresponding rotary/push button 14 is released from its locked position by pressing it, so that it projects out of front plate 12 as shown in the sole FIGURE for the rotary/push buttons 14 indicated with the numbers 2, 5, 6, and 8, so that the operator can receive audio data on the corresponding channels 24. The rotary/push buttons 14 having the numbers 1, 3, 4, and 7 are pushed into front plate 12, and the operator therefore cannot receive any audio data on the related channels 24. In this connection, the volume is regulated by rotating the rotary/push buttons 14 in question.

The operator can select the channels 24 by way of which he/she can transmit audio data, by means of selection switch 16. For this purpose, selection switch 16 is set to one of the selection positions 20 or to the further selection position 22. If selection switch 16 is in one of the selection positions 20, then the operator can transmit only by way of the channel 24 that is assigned to the rotary/push button 14 whose numbering corresponds to the numbering of the selected selection position 20. If, on the other hand, selection switch 16 is set to the further selection position 22, then the operator can transmit by way of all the channels 24 by way of which he/she can also receive audio data, unless these channels 24 are blocked for transmission operation by means of a blocking device 26. Pressing on/off switch 18 is a prerequisite for being able to transmit on one or more channels 24 simultaneously.

For this purpose, multiple logical links are provided between rotary/push buttons 14, selection switch 16, on/off switch 18, and blocking device 26. At first, a projected position of one of the rotary/push buttons 14 corresponds to a logic 1, while the position of one of the rotary/push buttons 14 in which it is pushed into front plate 12 corresponds to a logic 0. In first AND links 28, the binary signal of rotary/push buttons 14 is linked with the binary signals of blocking device 26 and further selection position 22, with an AND. When selection switch 16 is in further selection position 22, this position corresponds to a logic 1 at first AND links 28. Furthermore, predetermined binary signals are passed to first AND links 28 by blocking device 26. In the present case, blocking device 26 blocks the channels assigned to the rotary/push buttons 14 having the numbers 1 and 2, for transmission operation, if selection switch 16 is in the further selection position 22. A binary signal is passed, by first AND links 28, to OR links 30, and these links additionally receive a binary signal from one of the selection positions 20, in each instance. A binary signal goes from OR links 30 to second AND links 32, which furthermore receive a binary signal from on/off switch 18. A binary signal goes from second AND links 32 to transmission and reception channels 24. In the exemplary embodiment shown, in which selection switch 16 stands in further selection position 22, the operator can receive on the rotary/push buttons 14 having the numbers 2, 5, 6, and 8, as well as transmit on the channels 24 that are assigned to the rotary/push buttons 14 having the numbers 5, 6, and 8. In contrast, the channel assigned to the rotary/push button 14 having the number 2 is blocked by blocking device 26.

In summary, the following should be stated: The invention relates to a control panel 10 for a communications system of an aircraft, having at least one transmitter and at least one receiver, with multiple transmission and reception channels 24, having multiple operating elements 14 that have an on/off function, in each instance, whereby each operating element 14 is assigned to one of the transmission and reception channels 24, and whereby reception on the transmission and reception channel 24, in each instance, can be released by means of the on/off function, and having a selection switch 16 that has a selection position 20 for each transmission and reception channel 24, in which it releases the related transmission and reception channel 24 for transmission and blocks the other transmission and reception channels 24 for transmission. According to the invention, it is provided that the selection switch 16 has a further selection position 22, in which it releases the transmission and reception channels 24 that are released for reception by means of the operating elements 14, for transmission, and blocks the other transmission and reception channels 24 for transmission.

Although only at least one embodiment of the present invention has been shown and described, it is to be understood that many changes and modifications may be made thereunto without departing from the spirit and scope of the invention.

What is claimed is:

1. A control panel for a communications system of an aircraft comprising
(a) at least one transmitter;
(b) at least one receiver;
(c) a plurality of transmission and reception channels;
(d) a plurality of operating elements, each operating element having an on/off function and being associated with a respective transmission and reception channel, wherein reception on each transmission and reception channel is releasable via the on/off function of the respective operating element associated with the transmission and reception channel; and
(e) a selection switch having a selection position for each transmission and reception channel for releasing the transmission and reception channel associated with the selection position and blocking other transmission and reception channels of the plurality of transmission and reception channels;
wherein the selection switch has a transmission release selection position for releasing the transmission and reception channels released for reception via the operating elements for transmission and blocking other transmission and reception channels of the plurality of transmission channels for transmission.

2. The control panel according to claim 1, wherein each operating element has a respective volume control.

3. The control panel according to claim 2, wherein the operating elements are rotary/push buttons for operating the on/off function via pushing and the volume control via rotation.

4. The control panel according to claim 1, further comprising an on/off switch connected with the selection switch via a logical AND, said on/off switch releasing or blocking the transmission and reception channels released by the selection switch, for transmission.

5. The control panel according to claim 1, further comprising a blocking device for blocking pre-selected transmission and reception channels for transmission.
